(19) United States
(12) Patent Application Publication
(10) Pub. No.: US 2016/0260975 A1
(43) Pub. Date: Sep. 8, 2016

(54) RESIN COMPOSITION FOR SECONDARY BATTERY ELECTRODES, SOLUTION OR DISPERSION FOR SECONDARY BATTERY ELECTRODES, SLURRY FOR SECONDARY BATTERY ELECTRODES, ELECTRODE FOR SECONDARY BATTERIES, AND SECONDARY BATTERY

(71) Applicant: Mitsubishi Rayon Co., Ltd., Tokyo (JP)

(72) Inventors: Kenichi ISHIGAKI, Otake-shi (JP); Mitsufumi NODONO, Otake-shi (JP); Fumino MOMOSE, Otake-shi (JP); Daisuke FUJIKAWA, Tokyo (JP); Akikazu MATSUMOTO, Otake-shi (JP); Hikaru MOMOSE, Otake-shi (JP)

(73) Assignee: MITSUBISHI RAYON CO., LTD., Tokyo (JP)

(21) Appl. No.: 15/030,468

(22) PCT Filed: Oct. 7, 2014
(86) PCT No.: PCT/JP2014/076829

§ 371 Date: Apr. 19, 2016

(30) Foreign Application Priority Data
Oct. 23, 2013 (JP) 2013-220544

(51) Int. Cl. H01M 4/62; H01M 10/0525; H01M 4/13

(52) U.S. Cl. CPC H01M 4/622; H01M 4/13; H01M 10/0525; H01M 4/625; H01M 4/587

(57) ABSTRACT

This resin composition for secondary battery electrodes contains (A) a polymer that contains a vinyl cyanide unit but does not contain an acidic group, (B) a polymer that contains an acidic group and (C) a compound that contains a hydroxyl group.

### TECHNICAL FIELD

The present invention relates to a resin composition for secondary battery electrodes, a solution or dispersion for secondary battery electrodes, a slurry for secondary battery electrodes, an electrode for secondary batteries, and a secondary battery.

This application is based upon and claims the benefit of priority of the prior Japanese Patent Application No. 2013-220544, filed in Japan on Oct. 23, 2013, the entire contents of which are incorporated herein by reference.

### BACKGROUND ART

Secondary batteries are used in light electrical consumer electronics applications such as notebook computers or cellular phones and as a storage battery for hybrid vehicles or electric vehicles. A lithium ion secondary battery is frequently used as a secondary battery.

As an electrode of a secondary battery, those equipped with a current collector and an agent mixture layer that is provided on the current collector and contains an electrode active material and a conductive auxiliary retained by a binder is generally used. Such an electrode is generally fabricated by preparing an agent mixture containing an electrode active material, a conductive auxiliary, and a binder, coating this on one surface or both surfaces of the current collector using a transfer roll or the like, and then drying and removing the solvent to form an agent mixture layer. Generally, in the step of coating the agent mixture on the current collector, the agent mixture is coated on the current collector unwound from the current collector roll and dried and the coated current collector is then wound on the electrode roll. Thereafter, it is compression-molded using a roll pressing machine or the like if necessary.

Hitherto, as a binder for secondary battery electrodes, for example, a fluorine-based polymer such as polyvinylidene fluoride (hereinafter, referred to as PVDF in some cases) is used as a binder for positive electrodes.

However, PVDF does not exhibit sufficient binding strength, and thus there is a problem that the adhesive property between the agent mixture layer using this and the current collector is insufficient. Particularly, in recent years, a lithium-containing metal oxide which contains nickel having a high energy density at a high ratio has been used as a positive electrode active material, and the adhesive property is likely to be insufficient as the gelation of PVDF is caused by high alkalinity of the active material when PVDF is used to retain such a positive electrode active material. It is difficult to improve battery performance such as the capacity, rate characteristics, and cycle characteristics of the secondary battery when the adhesive property between the agent mixture layer and the current collector is insufficient.

In order to cope with such a problem, it has been proposed to use a polyacrylonitrile-based (hereinafter, referred to as PAN in some cases) resin which exhibits electrochemical stability equivalent to PVDF and is less likely to be gel as a binder for secondary battery electrodes. In addition, it has been proposed to introduce a polar group such as a phosphoric acid group or a carboxyl group to a PAN-based resin in order to enhance the adhesive property to the current collector. (For example, Patent Documents 1 and 2)

However, a PAN-based resin has a more rigid molecular structure than PVDF, and thus there is a problem that the flexibility of the agent mixture layer to be formed and eventually the flexibility of the electrode deteriorate in the case of using this as a binder for secondary battery electrodes. The deterioration in flexibility of the agent mixture layer causes cracks (fissures, breakage, or the like) at the time of winding and folding and leads to deterioration in productivity of the electrode and battery performance of the secondary battery using this.

In Patent Document 2 above, it is described that the flexibility is improved by introducing a (meth)acrylic acid ester unit having a carboxyl group and a side chain with a great molecular weight such as 2-acryloyloxyethyl succinate into PAN through copolymerization.

However, it cannot be yet said that the flexibility of the agent mixture layer to be formed is sufficient even when using a PAN-based resin into which a (meth)acrylic acid ester unit is introduced by the method of Patent Document 2.

### CITATION LIST

### Patent Document

Patent Document 1: WO 2012/005358 A

Patent Document 2: JP 2005-327630 A

### DISCLOSURE OF THE INVENTION

### Problem to be Solved by the Invention

An object of the invention is to provide a resin composition, solution or dispersion, and slurry for secondary battery electrodes capable of forming an agent mixture layer which exhibits excellent adhesive property to a current collector and excellent flexibility.

In addition, an object of the invention is to provide an electrode for secondary batteries and a secondary battery that are equipped with an agent mixture layer which exhibits excellent adhesive property to a current collector and excellent flexibility.

### Means for Solving Problem

The invention has the following aspects.

[1]

A resin composition for secondary battery electrodes containing a polymer (A) which contains a vinyl cyanide unit but does not contain an acidic group, a polymer (B) which contains an acidic group, and a compound (C) which contains a hydroxyl group.

[2]

The resin composition for secondary battery electrodes described in [1], in which the acidic group is at least one kind selected from the group consisting of a phosphoric acid group, a carboxyl group, and a sulfonic acid group.

[3]

The resin composition for secondary battery electrodes described in [1] or [2], in which the acidic group is a phosphoric acid group.

[4]

The resin composition for secondary battery electrodes described in any one of [1] to [3], containing the polymer (A) at a proportion of from 29 to 98% by mass, the polymer (B) at a proportion of from 1 to 70% by mass, and the compound (C) at a proportion of from 1 to 70% by mass where a sum of the polymer (A), the polymer (B), and the compound (C) is 100% by mass.

[5]

The resin composition for secondary battery electrodes described in any one of [1] to [4], in which the compound (C) contains a plurality of hydroxyl groups.

[6]

The resin composition for secondary battery electrodes described in any one of [1] to [5], in which the compound (C) is a polycondensate containing a hydroxyl group.

[7]

The resin composition for secondary battery electrodes described in any one of [1] to [6], in which the compound (C) is a polycondensate of a polyhydric alcohol.

[8]

The resin composition for secondary battery electrodes described in any one of [1] to [7], in which the compound (C) is a polycondensate of a trihydric or higher alcohol.

[9]

A solution or dispersion for secondary battery electrodes containing the resin composition for secondary battery electrodes described in any one of [1] to [8] and a non-aqueous solvent, in which the resin composition for secondary battery electrodes is dissolved or dispersed in the non-aqueous solvent.

[10]

The solution or dispersion for secondary battery electrodes described in [9], in which the non-aqueous solvent is N-methylpyrrolidone.

[11]

A slurry for secondary battery electrodes containing the solution or dispersion for secondary battery electrodes described in [9] or [10] and an active material for secondary batteries.

[12]

The slurry for secondary battery electrodes described in [11], further containing a conductive auxiliary.

[13]

An electrode for secondary batteries including a current collector and an agent mixture layer that is provided on the current collector and formed from the slurry for secondary battery electrodes described in [11] or [12].

[14]

A secondary battery including the electrode for secondary batteries described in [13].

### Effect of the Invention

According to the invention, it is possible to provide a resin composition for secondary battery electrodes, a solution or dispersion for secondary battery electrodes, and a slurry for secondary battery electrodes that are capable of forming an agent mixture layer which exhibits excellent adhesive property to a current collector and excellent flexibility.

In addition, according to the invention, it is possible to provide an electrode for secondary batteries and a secondary battery that are equipped with an agent mixture layer which exhibits excellent adhesive property to a current collector and excellent flexibility.

### MODE(S) FOR CARRYING OUT THE INVENTION

### Resin Composition for Secondary Battery Electrodes

The resin composition for secondary battery electrodes of the invention is one that contains a polymer (A) which contains a vinyl cyanide unit but does not contain an acidic group, a polymer (B) which contains an acidic group, and a compound (C) which contains a hydroxyl group.

Hereinafter, the secondary battery will be also simply referred to as the “battery”. In addition, the resin composition for secondary battery electrodes will be also simply referred to as the “resin composition”.

<Polymer (A)>

The vinyl cyanide unit means a constitutional unit that is derived from a vinyl cyanide monomer.

Examples of the vinyl cyanide monomer may include acrylonitrile, methacrylonitrile, α-cyanoacrylate, dicyanovinylidene, and fumaronitrile. These vinyl cyanide monomers may be used singly or two or more kinds thereof may be used concurrently.

As the vinyl cyanide monomer, acrylonitrile is preferable among those mentioned above from the viewpoint of ease of polymerization and of being available at low cost.

The polymer (A) may be one that is composed of only the vinyl cyanide unit or one that further contains a constitutional unit (arbitrary constitutional unit) other than the vinyl cyanide unit if necessary. It is possible to adjust the adhesive property of the agent mixture layer to the current collector or the mechanical properties such as rigidity and bending strength of the agent mixture layer by the kind or content of the arbitrary constitutional unit.

As the monomer (arbitrary monomer) from which the arbitrary constitutional unit is derived, one that does not contain an acidic group but is copolymerizable with the vinyl cyanide monomer, and it is possible to appropriately select a monomer which forms a resin used as a binder for battery electrodes among known monomers and to use it.

Examples of the arbitrary monomer in the polymer (A) may include an alkyl (meth)acrylate, a vinyl halide monomer, an aromatic vinyl monomer, a maleimide, a (meth)acrylamide, and vinyl acetate.

Incidentally, the “vinyl monomer” is a compound which has at least one vinyl group or an α-methyl vinyl group obtained by substituting a hydrogen atom bonded to the carbon atom at the α-position of a vinyl group with a methyl group.

Examples of the alkyl (meth)acrylate may include ethyl (meth)acrylate, propyl (meth)acrylate, butyl (meth)acrylate, and hexyl (meth)acrylate.

Examples of the vinyl halide monomer may include vinyl chloride, vinyl bromide, and vinylidene chloride.

Examples of the aromatic vinyl monomer may include styrene and α-methylstyrene.

Examples of the maleimide may include maleimide and phenyl maleimide.

These arbitrary monomers may be used singly or two or more kinds thereof may be used concurrently.

The polymer (A) is preferably a polymer which has a vinyl cyanide unit as the main component. The solubility or dispersibility of the resin composition in a non-aqueous solvent is improved when a vinyl cyanide unit is a main component, and thus the adhesive property of the agent mixture layer using this as a binder to the current collector is improved.

The term “main component” means that the content of the vinyl cyanide unit is more than 50% by mole and 100% by mole or less where the sum of all the constitutional units that constitute the polymer (A) is 100% by mole.

The content of the vinyl cyanide unit in the polymer (A) is preferably 90% by mole or more and 100% by mole or less with respect to the sum of all the constitutional units that constitute the polymer (A).

The weight average molecular weight of the polymer (A) is preferably in a range of 1,000 to 5,000,000, more preferably from 30,000 to 1,000,000, even more preferably from 30,000 to 500,000, and even more preferably from 50,000 to 500,000.

The weight average molecular weight of the polymer (A) can be measured by gel permeation chromatography (GPC) using N,N-dimethylformamide (DMF) as a solvent and polystyrene as a standard.

As the polymer (A), commercially available one or one that is manufactured by a known manufacturing method may be used.

The polymer (A) can be manufactured by a known polymerization method. For example, the polymer (A) can be manufactured by putting a vinyl cyanide monomer and an arbitrary monomer if necessary into a solvent and holding the solution at a polymerization temperature of from 0 to 90° C. and preferably from 50 to 60° C. for a polymerization time of from 1 to 10 hours and preferably from 2 to 4 hours.

When conducting the polymerization, it is preferable to allow the polymerization to proceed while adding the vinyl cyanide monomer into the solvent dropwise since a great amount of heat is generated during the polymerization of a vinyl cyanide monomer.

Examples of the polymerization method may include bulk polymerization, suspension polymerization, emulsion polymerization, and solution polymerization, and suspension polymerization is preferable among them since it is easy to manufacture and to carry out the post-treatment (recovery and purification) step.

Suspension polymerization is a method in which the monomer (a vinyl cyanide monomer and an arbitrary monomer if necessary in the case of the polymer (A)) to be polymerized and a polymerization initiator are dispersed in water and the dispersion is held at an arbitrary temperature.

As the polymerization initiator used in the suspension polymerization, a water-soluble polymerization initiator is preferable since it exhibits excellent polymerization initiation efficiency and the like.

Examples of the water-soluble polymerization initiator may include a persulfate salt such as potassium persulfate, ammonium persulfate, or sodium persulfate; a water-soluble peroxide such as hydrogen peroxide; and a water-soluble azo compound such as 2,2′-azobis(2-methylpropionamidine) dihydrochloride. Among them, a persulfate salt is preferable since the polymerization is easy.

An oxidizing agent such as a persulfate salt can be used as a redox initiator in combination with a reducing agent such as sodium bisulfite, ammonium bisulfite, sodium thiosulfate, or hydrosulfite and a polymerization accelerator such as sulfuric acid, iron sulfate, or copper sulfate.

It is possible to use a chain transfer agent in the suspension polymerization for the purpose of molecular weight adjustment and the like.

Examples of the chain transfer agent may include a mercaptan compound, thioglycol, carbon tetrachloride, α-methylstyrene dimer, and a hypophosphite salt, and a mercaptan compound is preferable among them.

It is possible to use a solvent other than water in the suspension polymerization in order to adjust the particle size of the polymer (A) to be obtained.

Examples of the solvent other than water may include an amide such as N-methylpyrrolidone (NMP), N,N-dimethylacetamide, or N,N-dimethylformamide; a urea such as N,N-dimethylethyleneurea, N,N-dimethylpropyleneurea, or tetramethylurea; a lactone such as γ-butyrolactone or γ-caprolactone; a carbonate such as propylene carbonate; a ketone such as acetone, methyl ethyl ketone, methyl isobutyl ketone, or cyclohexanone; an ester such as methyl acetate, ethyl acetate, n-butyl acetate, butyl cellosolve acetate, butyl carbitol acetate, ethyl cellosolve acetate, or ethyl carbitol acetate; a glyme such as diglyme, triglyme, or tetraglyme; a hydrocarbon such as toluene, xylene, or cyclohexane; a sulfoxide such as dimethyl sulfoxide; a sulfone such as sulfolane; and an alcohol such as methanol, isopropanol, or n-butanol. These solvents may be used in appropriate combination of one or more kinds thereof.

It is possible to use a surfactant in the case of manufacturing the polymer (A) by emulsion polymerization.

Examples of the surfactant may include an anionic surfactant such as a dodecylsulfate salt or a dodecylbenzenesulfonate salt; a nonionic surfactant such as a polyoxyethylene alkyl ether or a polyoxyethylene alkyl ester; and a cationic surfactant such as an alkyl trimethyl ammonium salt or an alkylamine.

These surfactants may be used in appropriate combination of one or more kinds thereof

In the case of using the resin composition as a binder for battery electrode, the resin composition is dissolved or dispersed in a non-aqueous solvent such as NMP and coated on the current collector in a state of a slurry obtained by further adding an active material for secondary batteries, a conductive auxiliary, and the like thereto. At this time, a great amount of component (solvent-insoluble component) that is insoluble in the non-aqueous solvent in the slurry adversely affects the slurry properties or the adhesive state between the electrode active material and the electrode active material and the adhesive state between the electrode active material and the current collector in the agent mixture layer to be formed. For this reason, the solvent-insoluble component (25° C.) in the polymer (A) is preferably 50% by mass or less and more preferably 10% by mass or less from the viewpoint of the performance and quality management. The adhesive property of the resin composition to the electrode active material or the current collector is favorable when the solvent-insoluble component is 50% by mass or less.

The solvent-insoluble component can be adjusted by increasing or decreasing the amount of polymerization initiator or chain transfer agent when manufacturing the polymer (A). There is a tendency that the molecular weight increases and the insoluble component increases when the polymerization initiator or the chain transfer agent is in a small amount.

The polymer (A) to be contained in the resin composition may be one kind or two or more kinds.

The proportion of the polymer (A) is preferably from 29 to 98% by mass, more preferably from 30 to 95% by mass, more preferably from 40 to 92% by mass, even more preferably from 50 to 92% by mass, and even more preferably from 70 to 90% by mass where the sum of the polymer (A), the polymer (B), and the compound (C) which are contained in the resin composition is 100% by mass. The coating stability of the slurry containing the resin composition is excellent when the content of the polymer (A) is equal to or more than the lower limit value of the above range, and the flexibility of the agent mixture layer to be formed by coating the slurry is superior when the content is equal to or less than the upper limit value of the above range.

<Polymer (B)>

The polymer (B) is a polymer which contains an acidic group.

Examples of the acidic group may include a phosphoric acid group, a carboxyl group, a sulfonic acid group, and a phenolic hydroxyl group. Among these, at least one kind selected from the group consisting of a phosphoric acid group, a carboxyl group, and a sulfonic acid group is preferable and a phosphoric acid group is even more preferable from the viewpoint of a high effect of improving the adhesive property to the current collector. The acidic group contained in the polymer (B) may be one kind or two or more kinds.

Examples of the polymer (B) may include a polymer which includes an acidic group-containing unit.

Examples of the acidic group-containing monomer from which the acidic group-containing unit is derived may include a phosphoric acid group-containing monomer and any salt thereof, a carboxyl group-containing monomer and any salt thereof, a sulfonic acid group-containing vinyl monomer and any salt thereof, and a phenolic hydroxyl group-containing vinyl monomer and any salt thereof.

As the phosphoric acid group-containing monomer, a phosphoric acid group-containing vinyl monomer is preferable and a phosphoric acid group-containing (meth)acrylate and a phosphoric acid group-containing allyl compound are more preferable.

In addition, as the phosphoric acid group-containing monomer, a monofunctional phosphoric acid group-containing monomer having one polymerizable functional group (a vinyl group, an α-methyl vinyl group, or the like) is preferable.

Examples of the phosphoric acid group-containing (meth)acrylate may include 2-(meth)acryloyloxyethyl acid phosphate, 2-(meth)acryloyl oxyethyl acid phosphate monoethanolamine salt, diphenyl((meth)acryloyloxyethyl) phosphate, (meth)acryloyloxy propyl acid phosphate, 3-chloro-2-acid-phosphoxypropyl (meth)acrylate, acid phosphooxypolyoxyethylene glycol mono(meth)acrylate, and acid phosphoxypolyoxypropylene glycol (meth)acrylate.

Examples of the phosphoric acid group-containing allyl compound may include allyl alcohol acid phosphate.

In addition to these monofunctional phosphate group-containing monomers, a bifunctional phosphoric acid group-containing monomer may be used in the range in which the deterioration in adhesive property to the current collector is not caused.

Among these phosphoric acid group-containing monomers, 2-methacryloyloxyethyl acid phosphate is preferable since it exhibits excellent adhesive property to the current collector and excellent handling property at the time of manufacturing an electrode. 2-methacryloyloxyethyl acid phosphate is commercially available as the LIGHT ESTER P1-M (trade name, manufactured by KYOEISHA CHEMICAL Co., LTD.).

Incidentally, the term “acid” means a phosphorus compound having a hydroxyl group bonded to a phosphorus atom. For example, the “acid phosphate” is a phosphorus compound (monoester or diester of phosphoric acid) in which one or two hydroxyl groups among the three hydroxyl groups bonded to the phosphorus atom of phosphoric acid are esterified.

Examples of the carboxyl group-containing monomer may include (meth)acrylic acid, itaconic acid, and crotonic acid.

Examples of the sulfonic acid group-containing vinyl monomer may include (meth)allylsulfonic acid, (meth)allyloxybenzenesulfonic acid, styrenesulfonic acid, and 2-acrylamido-2-methyl propanesulfonic acid.

The content of the acidic group-containing unit in the polymer (B) is preferably from 0.01 to 20% by mole and more preferably from 0.1 to 10% by mole with respect to the sum (100% by mole) of all the constitutional units that constitute the polymer (B). It is possible to contain an acidic group in a sufficient amount and the adhesive property of the agent mixture layer to the current collector is superior when the content of the acidic group-containing unit is equal to or more than the lower limit value of the above range. The polymer (B) easily dissolves in a non-aqueous solvent and the adhesive property of the agent mixture layer to the current collector is superior when the content of the acidic group-containing unit is equal to or less than the upper limit value of the above range.

The polymer (B) preferably includes a vinyl cyanide unit in addition to the acidic group-containing unit.

The vinyl cyanide unit is the same as the vinyl cyanide unit mentioned in the description on the polymer (A).

The vinyl cyanide unit contained in the polymer (B) may be one kind or two or more kinds.

The content of the vinyl cyanide unit in the polymer (B) is preferably from 80 to 99.99% by mole and more preferably from 90 to 99.9% by mole with respect to the sum (100% by mole) of all the constitutional units that constitute the polymer (B). The polymer (B) easily dissolves in a non-aqueous solvent and the adhesive property of the agent mixture layer to the current collector is superior when the content of the vinyl cyanide unit is equal to or more than the lower limit value of the above range. It is possible to contain an acidic group in a sufficient amount and the adhesive property of the agent mixture layer to the current collector is superior when the content of the vinyl cyanide unit is equal to or less than the upper limit value of the above range.

The polymer (B) may further contain a constitutional unit (arbitrary constitutional unit) other than the acidic group-containing unit and the vinyl cyanide unit if necessary. It is possible to adjust the mechanical properties such as rigidity and bending strength of the agent mixture layer by the arbitrary constitutional unit.

Examples of the arbitrary monomer in the polymer (B) may include an alkyl (meth)acrylate, a vinyl halide monomer, an aromatic vinyl monomer, a maleimide, a (meth)acrylamide, and vinyl acetate. Specific examples of these monomers may include the same ones as those mentioned in the description on the arbitrary constitutional unit of the polymer (A).

The arbitrary monomer may be used singly or two or more kinds thereof may be used concurrently.

The content of the arbitrary constitutional unit in the polymer (B) is preferably from 0 to 19.99% by mole with respect to the sum (100% by mole) of all the constitutional units that constitute the polymer (B). At this time, it is preferable that the content of the vinyl cyanide unit in the polymer (B) is from 80 to 99.99% by mole and the content of the acidic group-containing unit is from 0.01 to 20% by mole.

The content of the arbitrary constitutional unit in the polymer (B) is more preferably from 0 to 4% by mole. At this time, it is preferable that the content of vinyl cyanide unit in the polymer (B) is from 90 to 99.9% by mole and the content of the acidic group-containing unit is from 0.1 to 10% by mole.

The weight average molecular weight of the polymer (B) is preferably in a range of from 1,000 to 5,000,000, more preferably from 30,000 to 1,000,000, even more preferably from 30,000 to 500,000, and even more preferably from 50,000 to 500,000.

The weight average molecular weight of the polymer (B) can be measured by the same method as that measuring the weight average molecular weight of the polymer (A).

As the polymer (B), a commercially available one or one that is manufactured by a known manufacturing method may be used.

The polymer (B) can be manufactured by a known polymerization method. For example, the polymer (B) can be manufactured by the same method as the manufacturing method mentioned in the description on the polymer (A) described above except that the acidic group-containing monomer is used as an essential monomer.

As described above, a component (solvent-insoluble component) that is insoluble in a non-aqueous solvent adversely affects the slurry properties or the adhesive state between the electrode active material and the electrode active material and the adhesive state between the electrode active material and the current collector in the agent mixture layer to be formed. For this reason, the solvent-insoluble component (25° C.) in the polymer (B) is preferably 50% by mass or less and more preferably 10% by mass or less from the viewpoint of the performance and quality management. The adhesive property of the resin composition to the electrode active material or the current collector is favorable when the solvent-insoluble component is 50% by mass or less.

The polymer (B) contained in the resin composition may be one kind or two or more kinds.

The proportion of the polymer (B) is preferably from 1 to 70% by mass, more preferably from 2 to 50% by mass, even more preferably from 4 to 30% by mass, and even more preferably 6 to 25% by mass where the sum of the polymer (A), the polymer (B), and the compound (C) which are contained in the resin composition is 100% by mass. The flexibility of the agent mixture layer to be formed by coating the slurry is superior when the content of the polymer (B) is equal to or less than the upper limit value of the above range. The adhesive property of the agent mixture layer to the current collector is superior when the content of the polymer (B) is equal to or more than the lower limit value of the above range.

<Compound (C)>

The compound (C) is a compound which contains a hydroxyl group.

The compound (C) is selected from the group consisting of a monomer containing a hydroxyl group and a polymer containing a hydroxyl group.

Examples of the monomer having a hydroxyl group may include a glycol, a glycerin, vinyl alcohol, a glycol ester of (meth)acrylic acid, a sugar alcohol ester of (meth)acrylic acid, a vinyl ester of a hydroxy acid, a hydroxyalkyl vinyl ether, a polyhydric phenol, a sugar alcohol, and a monosaccharide.

Specific examples of the monomer having a hydroxyl group may include ethylene glycol, propylene glycol, butylene glycol, hexylene glycol, 3-methyl-1,3-butanediol, glycerin, hydroxymethyl (meth)acrylate, hydroxyethyl (meth)acrylate, hydroxypropyl (meth)acrylate, hydroxybutyl (meth)acrylate, hydroxymethyl (meth)acrylate, hydroxyethyl (meth)acrylate, hydroxypropyl (meth)acrylate, hydroxybutyl (meth)acrylate, hydroxymethyl vinyl ether, hydroxyethyl vinyl ether, hydroxypropyl vinyl ether, hydroxybutyl vinyl ether, inositol, xylose, pentaerythritol, dipentaerythritol, resorcinol, catechol, hydroquinone, benzenetriol, hexahydroxybenzene, mannitol, trehalose, erythritol, xylitol, sorbitol, glucose, fructose, and galactose.

The polymer containing a hydroxyl group may be a dimer or higher one that includes a constitutional unit having a hydroxyl group.

Examples thereof may include a polymer of a monomer which contains at least one kind selected from the group consisting of a glycol, a glycerin, vinyl alcohol, a glycol ester of (meth)acrylic acid, a sugar alcohol ester of (meth)acrylic acid, a vinyl ester of a hydroxy acid, a hydroxyalkyl vinyl ether, a sugar alcohol, and a monosaccharide. Specific examples of such a polymer may include polyethylene glycol, polypropylene glycol, polybutylene glycol, polyglycerin, starch, pullulan, pectin, chitin, chitosan, cellulose, carboxymethyl cellulose, acetyl cellulose, sucrose, lactose, and maltose.

Other examples of the polymer containing a hydroxyl group may include polyvinyl alcohol (acetic acid ester may partially remain), an ethylene-vinyl alcohol copolymer (acetic acid ester may partially remain), and a polyvinyl butyral-vinyl alcohol copolymer (acetic acid ester may partially remain) which are synthesized from a vinyl acetate copolymer through saponification.

The compound (C) is preferably a compound which contains a plurality of hydroxyl groups from the viewpoint of improving flexibility. As the compound containing a plurality of hydroxyl groups, a glycol, a glycerin, and an erythritol are preferable.

The compound (C) is preferably a polycondensate containing a hydroxyl group and more preferably a condensate of a polyhydric alcohol from the viewpoint of being hardly eluted into the electrolytic solution. Examples of the condensate of a polyhydric alcohol may include polyethylene glycol and polyglycerin.

As the compound (C), a polycondensate of a trihydric or higher alcohol is even more preferable. Examples of the polycondensate of a trihydric or higher alcohol may include polyglycerin.

The molecular weight of the compound (C) is preferably from 100 to 3,000, more preferably from 200 to 1000, and even more preferably from 400 to 750. The compound (C) in the agent mixture layer is hardly eluted into the electrolytic solution when the molecular weight of the compound (C) is equal to or more than the lower limit value of the above range. The compound (C) is easily dissolved or dispersed in a non-aqueous solvent when the molecular weight of the compound (C) is equal to or less than the upper limit value of the above range.

The melting point or softening point of the compound (C) is preferably 100° C. or lower, more preferably 80° C. or lower, and even more preferably 60° C. or lower. The battery operating temperature is generally 100° C. or lower, and thus the flexibility improving effect is likely to be exerted when the melting point or softening point of the compound (C) is 100° C. or lower.

The melting point or softening point of the compound (C) can be generally measured using a thermal analyzer. For example, the melting point can be determined through the measurement conducted in conformity with JIS K0064 or the measurement by differential scanning calorimetry (DSC). In addition, the softening point can be measured using a thermal mechanical analyzer (TMA) in conformity with JIS K7196.

The boiling point of the compound (C) is preferably a temperature that is equal to or higher than the boiling point of the non-aqueous solvent to be used for dissolving or dispersing the resin composition, more preferably a temperature that is equal to or higher than the (boiling point of the non-aqueous solvent+30° C.), and even more preferably a temperature that is equal to or higher than the (boiling point of the non-aqueous solvent+80° C.) from the viewpoint of preventing the evaporation of the compound (C) in the drying step at the time of manufacturing the electrode for batteries. For example, in the case of using NMP (boiling point: 208° C.) as a non-aqueous solvent, the boiling point of the compound (C) is preferably 240° C. or higher, more preferably 250° C. or higher, and even more preferably 300° C. or higher.

The boiling point of the compound (C) is measured using a thermobalance (TG), for example.

It is preferable that the compound (C) has a low solubility in the electrolytic solution to be used in the battery in consideration of the influence on the battery properties. Specifically, it is preferable that the solubility of the compound (C) in a mixed solvent (80° C.) of ethylene carbonate (hereinafter, abbreviated to EC in some cases) and diethyl carbonate (hereinafter, abbreviated to DEC in some cases) at a volume ratio of 1:1 is less than 1% by mass.

Incidentally, the solubility of the compound (C) in a mixed solvent is employed as an indicator of the solubility of the compound (C) in the electrolytic solution to be used in a battery, but the electrolytic solution to be used in a battery is not limited to the mixed solvent.

The compound (C) may be used singly or two or more kinds thereof may be used concurrently.

The proportion of the compound (C) is preferably from 1 to 70% by mass, more preferably from 1 to 50% by mass, even more preferably from 3 to 40% by weight, even more preferably 5 to 25% by weight, even more preferably 5 to 15% by mass, and even more preferably 7 to 15% by mass where the sum of the polymer (A), the polymer (B), and the compound (C) which are contained in the resin composition is 100% by weight. The flexibility of the agent mixture layer is superior when the content of the compound (C) is equal to or more than the lower limit value of the above range, and the adhesive property of the agent mixture layer to the current collector is superior when the content of the compound (C) is equal to or less than the upper limit value of the above range.

The resin composition of the invention is used in the manufacture of an electrode for batteries as a composition for battery electrodes.

The form of composition for battery electrodes is not particularly limited, and examples thereof may include a powder form and a solution or dispersion form in which the resin composition of the invention is dissolved or dispersed in a solvent such as NMP.

The content of the resin composition of the invention in the composition for battery electrodes is preferably from 50 to 100% by mass and more preferably from 80 to 100% by mass in a case in which the composition for battery electrodes is a powder. The effect of the invention is likely to be exerted when the content is equal to or more than the lower limit value of the above range.

The content of the resin composition of the invention in the composition for battery electrodes is preferably from 0.5 to 10% by mass and more preferably from 0.5 to 2% by mass in a case in which the composition for battery electrodes is a solution or dispersion. The effect of the invention is likely to be exerted when the content is equal to or more than the lower limit value of the above range, and the resin composition is likely to be uniformly dispersed when the content is equal to or less than the upper limit value of the above range.

Here, the content of the resin composition in the invention refers to the total amount of the polymer (A), the polymer (B), and the compound (C).

The content of the resin composition of the invention in the composition for battery electrodes is the “total amount of the polymer (A), the polymer (B), and the compound (C)” with respect to the “total mass of the composition for battery electrodes”.

In a case in which the composition for battery electrodes is a solution or dispersion, a non-aqueous solvent is preferably used as the solvent for dissolving or dispersing the resin composition.

The non-aqueous solvent is a solvent other than water. Examples of the non-aqueous solvent may include NMP, a mixed solution of NMP and an ester-based solvent (ethyl acetate, n-butyl acetate, butyl cellosolve acetate, butyl carbitol acetate, or the like), or a mixed solution of NMP and a glyme-based solvent (or the like). In addition, water may be used concurrently. These solvents may be used singly or in appropriate combination of two or more kinds thereof

The composition for battery electrodes may further contain a component (another arbitrary component) other than the polymer (A), the polymer (B), and the compound (C) if necessary.

Examples of another arbitrary component may include a known binder for battery electrodes (provided that the polymer (A) and the polymer (B) are excluded) and a viscosity modifier.

The composition for battery electrodes can be manufactured by utilizing a known method.

For example, in a case in which the composition for battery electrodes is in a powder form, examples of the manufacturing method may include a method in which a resin composition in a powder form is manufactured and an arbitrary component in a powder form is mixed therewith in a powder form if necessary.

In a case in which the composition for battery electrodes is a solution or dispersion form, examples thereof may include a method in which a resin composition in a powder form is manufactured, an arbitrary component in a powder form is mixed therewith in a powder form if necessary, and then a solvent such as NMP is added thereto and mixed and a method in which the polymer (A), the polymer (B), the compound (C), a solvent, and another arbitrary component if necessary are mixed together.

The resin composition in a powder form can be manufactured, for example, by mixing the polymer (A), the polymer (B), and the compound (C) with a solvent such as NMP and then drying the mixture to remove the solvent.

(Solution or Dispersion for Secondary Battery Electrodes)

The solution or dispersion for secondary battery electrodes (hereinafter, also simply referred to as the solution or dispersion) of the invention is one that contains the resin composition of the invention described above and a non-aqueous solvent and in which the resin composition is dissolved or dispersed in the non-aqueous solvent.

The solution or dispersion of the invention is the same as one in which a non-aqueous solvent is used as the solvent among the compositions for battery electrodes in a solution or dispersion form mentioned above.

As the non-aqueous solvent, NMP is preferable from the viewpoint of being able to easily dissolve various resins.

(Slurry for Secondary Battery Electrodes)

The slurry for secondary battery electrodes (hereinafter, also simply referred to as the slurry) of the invention is one that contains the solution or dispersion of the invention described above and an active material for secondary batteries.

The content of the solution or dispersion of the invention in the slurry of the invention is an amount in which the content of the resin composition of the invention is preferably from 0.1 to 10 parts by mass and more preferably from 1 to 5 parts by mass with respect to 100 parts by mass of the active material for secondary batteries. In addition, the solid content (the sum of the active material for secondary batteries, the conductive auxiliary, and the resin composition) in the slurry is preferably from 40 to 80% by mass.

<Active Material for Secondary Batteries>

The active material for secondary batteries (hereinafter, also simply referred to as the “active material”) is not particularly limited, and a known active can be used in accordance with the usage of the electrode for secondary batteries that is manufactured using the slurry. The active material is usually in a powder form.

For example, in the case of a lithium ion secondary battery, a substance which has a higher potential than the electrode active material for negative electrodes (negative electrode active material) and can absorb and release the lithium ion at the time of charge and discharge is used as the electrode active material for positive electrodes (positive electrode active material).

Examples of the positive electrode active material may include a lithium-containing metal composite oxide containing at least one or more kinds of metals selected from iron, cobalt, nickel, manganese, and vanadium and lithium and a conductive polymer such as polyaniline, polythiophene, polyacetylene and any derivative thereof, poly(para-phenylene) and any derivative thereof, polypyrrole and any derivative thereof, polythienylene and any derivative thereof, polypyridinediyl and any derivative thereof, and poly(arylene-vinylene) and any derivative thereof such as polyisothianaphthenylene and any derivative thereof. As the conductive polymer, a polymer of an aniline derivative that is soluble in an organic solvent is preferable. The positive electrode active material may be used singly or in appropriate combination of two or more kinds thereof.

Examples of the negative electrode active material may include a carbon material such as graphite, amorphous carbon, carbon fiber, coke, or activated carbon and a composite of the carbon material and a metal such as silicon, tin, or silver or an oxide thereof. The negative electrode active material may be used singly or in appropriate combination of two or more kinds thereof.

In the lithium ion secondary battery, it is preferable to use a lithium-containing metal composite oxide as the positive electrode active material and graphite as the negative electrode active material. The voltage of the lithium ion secondary battery is enhanced to, for example, 4 V or more by adopting such a combination.

The content of the active material in the slurry can be appropriately set in accordance with the content of the active material in the agent mixture layer to be formed from the slurry.

<Conductive Auxiliary>

The slurry may further contain a conductive auxiliary. It is possible to further enhance the battery performance by containing a conductive auxiliary. It is preferable to contain a conductive auxiliary particularly in a case in which the slurry is for the positive electrode.

Examples of the conductive auxiliary may include graphite, carbon black, and acetylene black. These conductive auxiliaries may be used singly or in appropriate combination of two or more kinds thereof.

The content of the conductive auxiliary in the slurry can be appropriately set in accordance with the content of the conductive auxiliary in the agent mixture layer to be formed from the slurry.

<Method for Preparing Slurry>

The slurry of the invention can be prepared by mixing the solution or dispersion of the invention, an active material, a conductive auxiliary, and a solvent if necessary. Alternatively, it can also be prepared by mixing the composition for battery electrodes in a powder form described above, an active material, a conductive auxiliary, and a solvent containing a non-aqueous solvent.

The solvent may be any solvent that can uniformly dissolve or disperse the composition for battery electrodes, and examples thereof may include NMP, a mixed solution of NMP and an ester-based solvent (ethyl acetate, n-butyl acetate, butyl cellosolve acetate, butyl carbitol acetate, or the like), or a mixed solution of NMP and a glyme-based solvent (or the like). In addition, water may be used concurrently. These solvents may be used singly or in appropriate combination of two or more kinds thereof.

The content of the solvent in the slurry may be the minimum amount required to keep the state in which the composition for battery electrodes is dissolved or dispersed at room temperature. In addition, the content of the solvent in the slurry is determined by taking the viscosity for easy coating into account.

(Electrode for Secondary Batteries)

The electrode for secondary batteries (hereinafter, also simply referred to as the electrode for batteries) of the invention is one that is equipped with a current collector and an agent mixture layer provided on the current collector.

In the electrode for batteries of the invention, the agent mixture layer is formed from the slurry of the invention described above. For example, the agent mixture layer is formed by coating the slurry on at least one surface of the plate-shaped current collector and then removing the solvent therefrom.

Hence, the agent mixture layer contains the resin composition of the invention described above, and the active material is retained by the resin composition in the agent mixture layer. The conductive auxiliary is also retained by the resin composition in a case in which the slurry contains a conductive auxiliary.

In the agent mixture layer, it is preferable that the compound (C) is compatible or dispersed in the polymer (A) and the polymer (B) in the resin composition.

In the agent mixture layer, the content of the resin composition of the invention is preferably from 0.5 to 10% by mass, more preferably from 0.5 to 4% by mass, and even more preferably from 0.5 to 2% by mass with respect to the total mass of the agent mixture layer. The adhesive property between the agent mixture layer and the current collector is further enhanced when the content is equal to or more than the lower limit value of the above range, and the resin composition exhibits excellent adhesive property when the content is equal to or less than the upper limit value of the above range and thus it is possible to favorably prevent peeling off between the agent mixture layer and the current collector.

The content of the active material in the agent mixture layer is not particularly limited, but it is preferably from 80 to 99.5% by mass, more preferably from 90 to 99% by mass, and even more preferably from 95 to 99% by mass with respect to the total mass of the agent mixture layer. The function as an agent mixture layer is sufficiently exerted when the content is equal to or more than the lower limit value of the above range, and the adhesive property between the agent mixture layer and the current collector is further enhanced when the content is equal to or less than the upper limit value of the above range.

The content of the conductive auxiliary in the agent mixture layer is not particularly limited, but it is preferably from 1 to 10% by mass and more preferably from 4 to 6% by mass with respect to the total mass of the agent mixture layer in the case of containing a conductive auxiliary. The function as an agent mixture layer is further enhanced when the content is equal to or more than the lower limit value of the above range, and the adhesive property between the agent mixture layer and the current collector is further enhanced when the content is equal to or less than the upper limit value of the above range.

The thickness of the agent mixture layer can be appropriately determined in accordance with the kind of the active material.

The thickness of the agent mixture layer is, for example, preferably from 70 to 110 μm and more preferably from 90 to 110 μm in a case in which the active material is lithium of a metal oxide.

The thickness of the agent mixture layer is, for example, preferably from 30 to 70 μm and more preferably from 50 to 70 μm in a case in which the active material is graphite.

The current collector may be any substance which exhibits conductivity, and examples thereof may include a metal such as aluminum, copper, or nickel.

The shape of the current collector can be determined in accordance with the form of the battery intended, and examples thereof may include a thin film form, a net form, and a fibrous form, and a thin film form is preferable among them.

The thickness of the current collector is not particularly limited, but it is preferably from 5 to 30 μm and more preferably from 8 to 25 μm.

<Method for Manufacturing Electrode for Batteries>

As the method for manufacturing an electrode for batteries, it is possible to use a method known in the prior art.

An electrode for batteries is obtained, for example, by coating the slurry of the invention on a current collector (coating step) and removing the solvent therefrom (solvent removing step) to form a solid layer (agent mixture layer) in which a binder for battery electrodes retains the electrode active material.

The method for coating the slurry in the coating step may be any method which can coat the slurry on a current collector in an arbitrary thickness, and examples thereof may include a method such as a doctor blade method, a dip method, a reverse roll method, a direct roll method, a gravure method, an extrusion method, or a brushing method.

The method for removing the solvent in the solvent removing step may be any method which can remove the solvent, and examples thereof may include a method to heat the current collector coated with the slurry to a temperature that is equal to or higher than the boiling point of the solvent and a method to evaporate the solvent under a reduced pressure condition.

The removal of the solvent is conducted under the condition in which the compound (C) is not removed (the compound (C) contained in the slurry all remains in the agent mixture layer). The temperature when removing the solvent varies depending on the kind of the compound (C), but it is typically from 25 to 200° C. and preferably from 90 to 140° C.

After the solvent removing step, the agent mixture layer may be rolled (rolling step) if necessary. It is possible to broaden the area of the agent mixture layer and to adjust to the thickness thereof to an arbitrary thickness by providing the rolling step.

The agent mixture layer may be provided on one surface or both surfaces of the current collector in a case in which the current collector is in a thin film or net form.

(Secondary Battery)

The secondary battery of the invention is one that is equipped with the electrode for batteries of the invention described above.

The structure of the secondary battery is not particularly limited, and it is possible to use a known structure. Examples thereof may include a structure in which a wound product obtained by superimposing an electrode for batteries of the positive electrode and an electrode for batteries of the negative electrode on each other via a separator and winding them is accommodated in a battery container together with an electrolytic solution.

In the secondary battery of the invention, either or both electrodes for batteries of the positive electrode and the negative electrode are the electrode for batteries of the invention.

It is possible to utilize known one as the electrode for batteries of the other electrode in a case in which either electrode for batteries of the positive electrode or the negative electrode is the electrode for batteries of the invention.

In the secondary battery of the invention, it is preferable that at least the positive electrode is the electrode for batteries of the invention.

As the electrolytic solution, it is possible to use a known electrolytic solution in accordance with the kind of the secondary battery.

As the secondary battery, a non-aqueous electrolyte secondary battery is suitable from the viewpoint of energy density.

The non-aqueous electrolyte secondary battery is a secondary battery using a non-aqueous electrolytic solution which does not contain water as the electrolytic solution, and a lithium ion secondary battery is preferable.

Examples of the non-aqueous electrolytic solution may include an electrolytic solution in which an electrolyte of a solid is dissolved in an organic solvent.

Examples of the organic solvent of the non-aqueous electrolytic solution may include a carbonate such as propylene carbonate, ethylene carbonate, butylene carbonate, dimethyl carbonate, diethyl carbonate, or methylethyl carbonate; a lactone such as γ-butyrolactone; an ether such as trimethoxymethane, 1,2-dimethoxyethane, diethyl ether, 2-ethoxyethane, tetrahydrofuran, or 2-methyltetrahydrofuran; a sulfoxide such as dimethyl sulfoxide; an oxolane such as 1,3-dioxolane, 4-methyl-1,3-dioxolane; a nitrogen-containing substance such as acetonitrile, nitromethane, or NMP; an ester such as methyl formate, methyl acetate, butyl acetate, methyl propionate, ethyl propionate, or a triester of phosphoric acid; a glyme such as diglyme, triglyme, or tetraglyme; a ketone such as acetone, diethyl ketone, methyl ethyl ketone, or methyl isobutyl ketone; a sulfone such as sulfolane; an oxazolidinone such as 3-methyl-2-oxazolidinone; a sultone such as 1,3-propane sultone, 4-butane sultone, or naphthasultone. These organic solvents may be used singly or in appropriate combination of two or more kinds thereof

Examples of the electrolyte may include LiClO₄, LiBF₄, LiI, LiPF₆, LiCF₃SO₃, LiCF₃CO₂, LiAsF₆, LiSbF₆, LiAlCl₄, LiCl, LiBr, LiB(C₂H₅)₄, LiCH₃SO₃, LiC₄F₉SO₃, Li(CF₃SO₂)₂N, and Li[(CO₂)₂]₂B.

As the electrolytic solution of a lithium ion secondary battery, those obtained by dissolving LiPF₆ in a carbonate are preferable.

As the separator, it is possible to use known ones. For example, it is possible to use a porous polymer film singly or a laminate of two or more porous polymer films as a separator. Examples of the porous polymer film may include a porous polymer film manufactured from a polyolefin-based polymer such as polyethylene, polypropylene, an ethylene/butene copolymer, an ethylene/hexene copolymer, or an ethylene/methacrylate copolymer. In addition, it is possible to use a usual porous nonwoven fabric, for example, a nonwoven fabric consisting of a glass fiber having a high melting point, a polyethylene terephthalate fiber, or an acrylic fiber as a separator, but it is not limited thereto.

<Method for Manufacturing Secondary Battery>

The method for manufacturing a secondary battery of the invention is not particularly restricted.

An example of the method for manufacturing a secondary battery will be described. First, an electrode for batteries of the positive electrode and an electrode for batteries of the negative electrode are wound via a separator to obtain a wound body. The wound body thus obtained is inserted into a battery can, and a tab terminal that has been welded to the current collector of the negative electrode in advance is welded to the bottom of the battery can. Subsequently, an electrolytic solution is injected into the battery can, a tab terminal that has been welded to the current collector of the positive electrode in advance is further welded to the lid of the battery, the lid is disposed on the top portion of the battery can via all insulating gasket, and the portion at which the lid and the battery can are in contact is sealed by caulking, thereby obtaining a secondary battery.

### EXAMPLES

Hereinafter, the invention will be described with reference to Examples, but the invention is not limited to Examples. Incidentally, the term “%” in the respective Examples represents “% by mass” unless otherwise stated.

The raw materials used in the respective Examples are as follows.

(Raw Materials Used)

Polymer (A1): polymer containing a vinyl cyanide unit (polyacrylonitrile, weight average molecular weight: 313,000) obtained in Production Example 1 to be described below.

Polymer (B1): phosphoric acid group-containing polymer (copolymer of acrylonitrile and phosphoric acid group-containing monomer, weight average molecular weight: 109,000, proportion of phosphoric acid group-containing monomer unit: 5.69% by mole of the total) obtained in Production Example 2 to be described below.

Compound (C): the following four kinds of compounds were used as the compound (C).

Diglycerin: “Diglycerin S” manufactured by SAKAMOTO YAKUHIN KOGYO CO., LTD.

Polyglycerin #500: “Polyglycerin #500” (polyglycerin having a weight average molecular weight of 500) manufactured by SAKAIVIOTO YAKUHIN KOGYO CO., LTD.

Polyethylene glycol 600: “Polyethylene glycol 600” (polyethylene glycol having an average molecular weight of from 560 to 640) manufactured by Wako Pure Chemical Industries, Ltd.

Erythritol: “Erythritol T” manufactured by Mitsubishi-Kagaku Foods Corporation.

### Production Example 1

### Synthesis of Polymer (A1)

Into a SUS314-made separable flask that was equipped with a stirrer, a thermometer, a cooling tube, and a nitrogen gas inlet tube and had a capacity of 2 liters, 940 g of distilled water was put, and a nitrogen gas was allowed to bubble therein for 15 minutes under a condition having a flow rate of 100 mL/min. The temperature thereof was raised to 60° C. while stirring, and the flow of nitrogen gas was switched to overflow.

Subsequently, 2.16 g of ammonium persulfate as a polymerization initiator, 6.48 g of 50% ammonium sulfite as a reducing agent, and 0.15 g of 0.1% iron sulfate as a polymerization accelerator were dissolved in 30 g of distilled water, and the solution was put into the separable flask.

A nitrogen gas was allowed to bubble in 100 g of acrylonitrile for 15 minutes, and the acrylonitrile was then added to the separable flask dropwise over 30 minutes. After the dropwise addition was completed, the polymerization was allowed to proceed for 2 hours at the same temperature by holding the state.

Thereafter, stirring was stopped, and the separable flask was cooled with water, this reaction mixture was suction-filtered and washed with 10 L of warm water at 55° C. The resultant was dried for 24 hours at 65° C., thereby obtaining the polymer (A1). The yield was 78%. The weight average molecular weight (Mw) of the polymer (A1) thus obtained by the GPC measurement (solvent: DMF, standard: polystyrene) was 313,000.

### Production Example 2

### Synthesis of Polymer (B1)

Into a SUS314-made separable flask that was equipped with a stirrer, a thermometer, a cooling tube, and a nitrogen gas inlet tube and had a capacity of 2 liters, 870 g of distilled water was put, and a nitrogen gas was allowed to bubble therein for 15 minutes under a condition having a flow rate of 100 mL/min. The temperature thereof was raised to 55° C. while stirring, and the flow of nitrogen gas was switched to overflow.

Subsequently, 2.88 g of ammonium persulfate as a polymerization initiator, 8.64 g of 50% ammonium sulfite, 0.054 g of 0.1% iron sulfate, and 30 g of distilled water were put into the separable flask.

A mixture was prepared by mixing 50.1 g of acrylonitrile and 15.62 g of the LIGHT ESTER P1-M (trade name, manufactured by KYOEISHA CHEMICAL Co., LTD., mixture of 2-methacryloyloxyethyl acid phosphate:bis(2-methacryloyloxyethyl) acid phosphate=80:20 (mass ratio)) as a phosphoric acid group-containing monomer and allowing a nitrogen gas to bubble therein for 15 minutes. After bubbling, this mixture was added to the separable flask dropwise over 30 minutes. After the dropwise addition was completed, the separable flask was held for 2 hours at the same temperature to conduct the polymerization.

After the polymerization was completed, stirring was stopped, and the separable flask was cooled with water, this reaction mixture was suction-filtered and washed with 10 L of warm water at 55° C. The resultant was dried for 24 hours at 65° C., thereby obtaining the polymer (B1). The Mw of the polymer (B1) thus obtained by the GPC measurement (solvent: DMF, standard: polystyrene) was 109,000. The proportion of the phosphoric acid group-containing monomer unit in the polymer (B1) was 5.69% by mole of the total.

### Example 1

### Preparation of Binder Solution

The polymer (A1), the polymer (B1), and diglycerin were mixed at a mass ratio of (A1):(B1):diglycerin=45:5:50 to prepare a binder (resin composition). NMP was added to the binder so as to have a solid content ratio of 10% and mixed for 3 minutes using a mixer to prepare a 10% NMP solution of the binder.

The solid content indicates the sum of the components (the sum of the polymer (A1), the polymer (B1), and diglycerin in the case of the above binder solution) other than the solvent (NMP).

<Fabrication of Electrode: Fabrication of Electrode Containing Lithium Cobalt Oxide as Active Material>

Into an ointment container, 10 g of lithium cobalt oxide (“Cell Seed C-5H” manufactured by Nippon Chemical Industrial CO., LTD.) and 0.5 g of acetylene black (trade name: Denka Black manufactured by Denka Company Limited) were put and kneaded for 30 seconds using a rotary and revolutionary mixer. Thereto, 3 g of the 10% NMP solution of the binder thus prepared and 1.09 g of NMP were added, and they were kneaded for 3 minutes using a mixer, and 0.83 g of NMP was further added thereto to have a total solid content ratio of 70%, thereby preparing a coating solution.

This coating solution was coated on an aluminum current collector foil using a doctor blade so as to be 21 mg/cm² after drying. Subsequently, the resultant was dried for 50 minutes at 80° C. by heating and further vacuum-dried for 12 hours at 60° C. to evaporate NMP, thereby forming an agent mixture layer. Thereafter, the laminate thus obtained was pressed using a roll press so as to have a density of the agent mixture layer of 3.0 g/cm³, thereby obtaining an electrode.

With regard to the electrode thus obtained, the adhesive property of the agent mixture layer to the current collector foil and the flexibility were evaluated by the following procedure.

<Evaluation on Adhesive Property>

The positive electrode was cut so as to have a width of 20 mm and a length of 80 mm, and the agent mixture layer surface of the cut piece was fixed to a polycarbonate sheet (width: 25 mm, length: 100 mm, thickness: 1 mm) using double-sided tape (“#570” manufactured by SEKISUI CHEMICAL CO., LTD.) to use as the test piece 1.

The test piece 1 was set in the TENSILON tester (“RTC-1210A” manufactured by ORIENTEC Co., LTD.,) for tensile strength test, the current collector foil was peeled off by 180° at 10 mm/min, and the peeling strength (N/cm) was measured. The test was carried out five times. The average value of the peel strength measured by five times of test was determined. The result (average value for peel strength) is presented in Table 1.

<Evaluation on Flexibility>

The electrode was cut into a piece of 3 cm×8 cm to use as the test piece 2. The following test was carried out with reference to JIS K-5600-5-1: 1999 (the paint general test method for flex resistance (cylindrical mandrel method)).

The test was carried out in an environment having a humidity of 10% or less and a temperature of about 25° C. The test piece 2 was placed so that the current collector foil surface was on the mandrel side, and the test piece was folded into two along the mandrel in the vicinity of the center (40 mm from the end) in the longitudinal direction. Thereafter, the presence or absence of the occurrence of breakage or fissures on the agent mixture layer of the test piece 2 was visually confirmed. This test was carried out for three test pieces 2. The mandrels used had a diameter of 32 mm, 25 mm, 20 mm, 16 mm, 10 mm, 8 mm, 6 mm, 5 mm, 3 mm, and 2 mm. The mandrel having the smallest diameter (minimum diameter) among the mandrels in which the occurrence of breakage or fissures was not observed on the agent mixture layer of the test piece 2 was confirmed, and the minimum diameter was adopted as the indicator of flexibility. It indicates that the flexibility of the agent mixture layer and eventually the flexibility of the electrode are higher as the minimum diameter is smaller. The result (minimum diameter) is presented in Table 1.

### Example 2

A binder was prepared by mixing the polymer (A1), the polymer (B1), and diglycerin at a mass ratio of (A1):(B1):diglycerin=63:7:30. NMP was added to the binder so as to have a solid content ratio of 10% and mixed for 3 minutes using a mixer, thereby preparing a 10% NMP solution of the binder.

The fabrication of the electrode, the evaluation on the adhesive property to the current collector foil, and the evaluation on the flexibility were conducted using the solution thus obtained in the same manner as in Example 1. The evaluation results are presented in Table 1.

### Example 3

A binder was prepared by mixing the polymer (A1), the polymer (B1), and diglycerin at a mass ratio of (A1):(B1):diglycerin=81:9:10. NMP was added to the binder so as to have a solid content ratio of 10% and mixed for 3 minutes using a mixer, thereby preparing a 10% NMP solution of the binder.

The fabrication of the electrode, the evaluation on the adhesive property to the current collector foil, and the evaluation on the flexibility were conducted using the solution thus obtained in the same manner as in Example 1. The evaluation results are presented in Table 1.

### Example 4

A binder was prepared by mixing the polymer (A1), the polymer (B1), and the Polyglycerin #500 at a mass ratio of (A1):(B1):Polyglycerin #500=45:5:50. NMP was added to the binder so as to have a solid content ratio of 10% and mixed for 3 minutes using a mixer, thereby preparing a 10% NMP solution of the binder.

The fabrication of the electrode, the evaluation on the adhesive property to the current collector foil, and the evaluation on the flexibility were conducted using the solution thus obtained in the same manner as in Example 1. The evaluation results are presented in Table 1.

### Example 5

A binder was prepared by mixing the polymer (A1), the polymer (B1), and the Polyglycerin #500 at a mass ratio of (A1):(B1):Polyglycerin #500=81:9:10. NMP was added to the binder so as to have a solid content ratio of 10% and mixed for 3 minutes using a mixer, thereby preparing a 10% NMP solution of the binder.

The fabrication of the electrode, the evaluation on the adhesive property to the current collector foil, and the evaluation on the flexibility were conducted using the solution thus obtained in the same manner as in Example 1. The evaluation results are presented in Table 1.

### Example 6

A binder was prepared by mixing the polymer (A1), the polymer (B1), and the Polyglycerin #500 at a mass ratio of (A1):(B1):Polyglycerin #500=63:27:10. NMP was added to the binder so as to have a solid content ratio of 10% and mixed for 3 minutes using a mixer, thereby preparing a 10% NMP solution of the binder.

The fabrication of the electrode, the evaluation on the adhesive property to the current collector foil, and the evaluation on the flexibility were conducted using the solution thus obtained in the same manner as in Example 1. The evaluation results are presented in Table 1.

### Example 7

A binder was prepared by mixing the polymer (A1), the polymer (B1), and the Polyglycerin #500 at a mass ratio of (A1):(B1):Polyglycerin #500=35:35:30. NMP was added to the binder so as to have a solid content ratio of 10% and mixed for 3 minutes using a mixer, thereby preparing a 10% NMP solution of the binder.

The fabrication of the electrode, the evaluation on the adhesive property to the current collector foil, and the evaluation on the flexibility were conducted using the solution thus obtained in the same manner as in Example 1. The evaluation results are presented in Table 1.

### Example 8

A binder was prepared by mixing the polymer (A1), the polymer (B1), and erythritol at a mass ratio of (A1):(B1):erythritol=72:8:20. NMP was added to the binder so as to have a solid content ratio of 10% and mixed for 3 minutes using a mixer, thereby preparing a 10% NMP solution of the binder.

The fabrication of the electrode, the evaluation on the adhesive property to the current collector foil, and the evaluation on the flexibility were conducted using the solution thus obtained in the same manner as in Example 1. The evaluation results are presented in Table 1.

### Example 9

A binder was prepared by mixing the polymer (A1), the polymer (B1), and the Polyethylene glycol 600 at a mass ratio of (A1):(B1):Polyethylene glycol 600=72:8:20. NMP was added to the binder so as to have a solid content ratio of 10% and mixed for 3 minutes using a mixer, thereby preparing a 10% NMP solution of the binder.

The fabrication of the electrode, the evaluation on the adhesive property to the current collector foil, and the evaluation on the flexibility were conducted using the solution thus obtained in the same manner as in Example 1. The evaluation results are presented in Table 1.

### Example 10

A binder was prepared by mixing the polymer (A1), the polymer (B1), and the Polyethylene glycol 600 at a mass ratio of (A1):(B1):Polyethylene glycol 600=81:9:10. NMP was added to the binder so as to have a solid content ratio of 10% and mixed for 3 minutes using a mixer, thereby preparing a 10% NMP solution of the binder.

The fabrication of the electrode, the evaluation on the adhesive property to the current collector foil, and the evaluation on the flexibility were conducted using the solution thus obtained in the same manner as in Example 1. The evaluation results are presented in Table 1.

### Example 11

A binder was prepared by mixing the polymer (A1), the polymer (B1), and the Polyethylene glycol 600 at a mass ratio of (A1):(B1):Polyethylene glycol 600=35:35:30. NMP was added to the binder so as to have a solid content ratio of 10% and mixed for 3 minutes using a mixer, thereby preparing a 10% NMP solution of the binder.

The fabrication of the electrode, the evaluation on the adhesive property to the current collector foil, and the evaluation on the flexibility were conducted using the solution thus obtained in the same manner as in Example 1. The evaluation results are presented in Table 1.

### Comparative Example 1

A binder was prepared by mixing the polymer (A1) and the polymer (B1) at a mass ratio of (A1):(B1)=90:10. NMP was added to the binder so as to have a solid content ratio of 10% and mixed for 3 minutes using a mixer, thereby preparing a 10% NMP solution of the binder.

The fabrication of the electrode, the evaluation on the adhesive property to the current collector foil, and the evaluation on the flexibility were conducted using the solution thus obtained in the same manner as in Example 1. The evaluation results are presented in Table 1.

### Comparative Example 2

A binder was prepared by mixing the polymer (A1) and the Polyethylene glycol 600 at a mass ratio of (A1):Polyethylene glycol 600=70:30. NMP was added to the binder so as to have a solid content ratio of 10% and mixed for 3 minutes using a mixer, thereby preparing a 10% NMP solution of the binder.

The fabrication of the electrode, the evaluation on the adhesive property to the current collector foil, and the evaluation on the flexibility were conducted using the solution thus obtained in the same manner as in Example 1. The evaluation results are presented in Table 1.

### Comparative Example 3

A binder was prepared by mixing the polymer (B1) and the Polyethylene glycol 600 at a mass ratio of (B1):Polyethylene glycol 600=90:10. NMP was added to the binder so as to have a solid content ratio of 10% and mixed for 3 minutes using a mixer, thereby preparing a 10% NMP solution of the binder.

The fabrication of the electrode, the evaluation on the adhesive property to the current collector foil, and the evaluation on the flexibility were conducted using the solution thus obtained in the same manner as in Example 1. The evaluation results are presented in Table 1.

TABLE 1

| | Composition ratio | | | Evaluation result | |
|---|---|---|---|---|---|
| | Polymer | Polymer | Compound | Adhesive property | Flexibility |
| | (A) | (B) | (C) | (N/cm) | (mm) |
| Example 1 | A1 | B1 | Diglycerin | 0.02 | 5 |
| | 45% | 5% | 50% | | |
| Example 2 | A1 | B1 | Diglycerin | 0.11 | 6 |
| | 63% | 7% | 30% | | |
| Example 3 | A1 | B1 | Diglycerin | 0.95 | 8 |
| | 81% | 9% | 10% | | |
| Example 4 | A1 | B1 | Polyglycerin #500 | 0.02 | 5 |
| | 45% | 5% | 50% | | |
| Example 5 | A1 | B1 | Polyglycerin #500 | 1.04 | 8 |
| | 81% | 9% | 10% | | |
| Example 6 | A1 | B1 | Polyglycerin #500 | 0.24 | 8 |
| | 63% | 27% | 10% | | |
| Example 7 | A1 | B1 | Polyglycerin #500 | 0.09 | 6 |
| | 35% | 35% | 30% | | |
| Example 8 | A1 | B1 | Erythritol | 0.15 | 10 |
| | 72% | 8% | 20% | | |
| Example 9 | A1 | B1 | Polyethylene glycol 600 | 0.18 | 8 |
| | 72% | 8% | 20% | | |
| Example 10 | A1 | B1 | Polyethylene glycol 600 | 0.59 | 10 |
| | 81% | 9% | 10% | | |
| Example 11 | A1 | B1 | Polyethylene glycol 600 | 0.06 | 10 |
| | 35% | 35% | 30% | | |
| Comparative | A1 | B1 | — | 1.18 | 16 |
| Example 1 | 90% | 10% | | | |
| Comparative | A1 | — | Polyethylene glycol 600 | <0.01 | 10 |
| Example 2 | 70% | | 30% | | |
| Comparative | — | B1 | Polyethylene glycol 600 | 0.32 | 16 |
| Example 3 | | 90% | 10% | | |

As presented in Table 1, the flexibility of the agent mixture layer is superior in Examples 1 to 11 in which the binder contains the polymer (A), the polymer (B), and the compound (C) as compared to Comparative example 1 in which the binder contains the polymer (A) and the polymer (B).

Meanwhile, the adhesive property between the agent mixture layer and the current collector foil was a significantly low value in Comparative Example 2 in which the binder only contains the polymer (A) and the compound (C) as compared to Examples 1 to 11 since the binder does not contain the polymer (B).

The result for Comparative Example 3 in which the binder only contains the polymer (B) and the compound (C) was that the flexibility of the agent mixture layer was inferior as compared to Examples 1 to 11 since the binder contains the polymer (B) in a great amount.

1. A resin composition for secondary battery electrodes comprising a polymer (A) which contains a vinyl cyanide unit but does not contain an acidic group, a polymer (B) which contains an acidic group, and a compound (C) which contains a hydroxyl group.

2. The resin composition for secondary battery electrodes according to claim 1, wherein the acidic group is at least one kind selected from the group consisting of a phosphoric acid group, a carboxyl group, and a sulfonic acid group.

3. The resin composition for secondary battery electrodes according to claim 1, wherein the acidic group is a phosphoric acid group.

4. The resin composition for secondary battery electrodes according to claim 1, comprising the polymer (A) at a proportion of from 29 to 98% by mass, the polymer (B) at a proportion of from 1 to 70% by mass, and the compound (C) at a proportion of from 1 to 70% by mass where a sum of the polymer (A), the polymer (B), and the compound (C) is 100% by mass.

5. The resin composition for secondary battery electrodes according to claim 1, wherein the compound (C) contains a plurality of hydroxyl groups.

6. The resin composition for secondary battery electrodes according to claim 1, wherein the compound (C) is a polycondensate containing a hydroxyl group.

7. The resin composition for secondary battery electrodes according to claim 1, wherein the compound (C) is a polycondensate of a polyhydric alcohol.

8. The resin composition for secondary battery electrodes according to claim 1, wherein the compound (C) is a polycondensate of a trihydric or higher alcohol.

9. A solution or dispersion for secondary battery electrodes comprising the resin composition for secondary battery electrodes according to claim 1 and a non-aqueous solvent, wherein the resin composition for secondary battery electrodes is dissolved or dispersed in the non-aqueous solvent.

10. The solution or dispersion for secondary battery electrodes according to claim 9, wherein the non-aqueous solvent is N-methylpyrrolidone.

11. A slurry for secondary battery electrodes comprising the solution or dispersion for secondary battery electrodes according to claim 9 and an active material for secondary batteries.

12. The slurry for secondary battery electrodes according to claim 11, further comprising a conductive auxiliary.

13. An electrode for secondary batteries comprising a current collector and an agent mixture layer that is provided on the current collector and formed from the slurry for secondary battery electrodes according to claim 11.

14. A secondary battery comprising the electrode for secondary batteries according to claim 13.
